(19) United States
(12) Patent Application Publication
(10) Pub. No.: US 2005/0120026 A1
(43) Pub. Date: Jun. 2, 2005

(54) Patent downloading system and method

(76) Inventors: Chung-I Lee, Tu-Chen (TW); Chien-Fa Yeh, Tu-Chen (TW); Zhi-Qiang Jiang, Shenzhen (CN); Xin Cao, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/994,917

(22) Filed: Nov. 22, 2004

(30) Foreign Application Priority Data
Nov. 29, 2003 (CN) 2003101124380

(51) Int. Cl. G06F 17/30

(52) U.S. Cl. 707/10

(57) ABSTRACT

A patent downloading system (1) for downloading patents (including published patent applications) from one or more patent web sites (2) includes a mirror web site (4) and an application server (3). The mirror web site includes a web server (40), which includes: a download period setting module (400) for setting download periods; a patent downloading module (402) for periodically downloading newly issued patents; and a patent index creating module (404) for creating a patent index for each newly downloaded patent. The application server includes a patent inquiry term receiving module (30) for receiving one or more patent inquiry terms; a patent information obtaining module (32) for obtaining information on patents to be downloaded; a patent existence determination module (34) for determining whether the patents exist in the mirror web site; and a downloading module (36) for downloading patents from the mirror web site.

### BACKGROUND OF THE INVENTION

1. Field of the Invention

The present invention relates generally to systems and methods for data downloading, and particularly to a patent downloading system and method which can provide a mirror web site for periodically downloading newly issued patents and newly published patent applications from public patent web sites.

2. Background of the Invention

As web communications technology advances, more and more web information-and-service suppliers are providing users with data search and data download capability via networks. Users can transmit data to the suppliers via the networks, and can directly download data from remote servers of the suppliers.

When users search for required data via the networks, most web sites have a link for data search. A user can set up a search query, and list all required data titles in the search query. The user then clicks on one of the titles or a related link on a web page with a computer mouse, in order to get a display of and/or download data relating to the title from a remote server supporting the web site. Generally, an information-providing web site provides a download function which allows users to download the data of only one title at a time, by clicking on the relevant link on the web page. If a user wants to download all data of multiple titles in a search query, he must manually download the data of each title one by one. When the required data comprise a large number of titles, this is exceedingly time-consuming. For instance, some data are stored in databases in the format of image files which must be downloaded one page at a time. In addition, if the network is temporarily blocked or experiences other difficulties, the data download procedure becomes more complicated and inefficient.

When searching and downloading data from the networks, multiple users in a same organization can cooperate as a group. The group accesses the networks via a common server of the organization that can store the data downloaded. The users in the group visit the common server via an intranet, and can retrieve data from and send data to the common server. The users in the group may deal with similar work of the organization, and thus need and use some common data. However, when an individual user downloads required data via the networks, the user may not know about the requirements of other users in the group. Therefore, identical data may be downloaded more than one time when it is required by more than one user in the group. This is unduly time-consuming and inefficient.

U.S. Pat. No. 6,339,785 discloses a data download system that can concurrently download a file from a plurality of remote servers. In the system, a client computer can download data from a plurality of remote servers via a communication network. The system can concurrently download a part of the file from each remote server and integrate the parts of the file into the single complete file in the client computer. However, this data download system cannot prevent repeated downloading of data that are already stored in a local database of the client computer, and further cannot re-download any data that are not successfully downloaded a first time. In addition, the system cannot adequately deal with network jams and other network difficulties efficiently.

Accordingly, what is needed is a system and method which can overcome the abovementioned problems.

### SUMMARY OF THE INVENTION

A main objective of the present invention is to provide a system and method which can provide a mirror web site for periodically downloading newly issued patents and newly published patent applications from patent web sites in order to avoid network jams. Unless otherwise indicated, the term “patent” as used herein is to be construed as including a published patent application, and the term “issued patent” as used herein is to be construed as including a published patent application.

Another objective of the present invention is to provide a system and method which can prevent repeated downloading of patents that are already stored in a local database.

To achieve the above objectives, a system for downloading patents from one or more patent web sites through a network comprises a mirror web site, an application server, a plurality of client computers, and a database linking to the application server through a connection. The mirror web site comprises: a patent database for storing newly issued patents downloaded from the patent web sites, and storing corresponding patent index lists; and a web server. The web server comprises: a download period setting module for setting download periods; a patent downloading module for periodically downloading newly issued patents at a predetermined download time of each download period; and a patent index creating module for creating a patent index for each newly downloaded patent. The application server comprises a patent inquiry term receiving module for receiving patent inquiry terms from any of the client computers; a patent information obtaining module for obtaining information on patents to be downloaded according to the received patent inquiry terms; a patent existence determination module for determining whether the patents to be downloaded exist in the mirror web site; and a downloading module for downloading the patents from the mirror web site if the patents exist in the mirror web site.

Further, a patent downloading method is also provided. The patent downloading method comprises the steps of: providing a mirror web site for periodically downloading newly issued patents from patent web sites and storing the downloaded patents; receiving a patent inquiry term; obtaining information on patents to be downloaded according to the received patent inquiry term; determining whether the patents to be downloaded exist in the mirror web site; and downloading the patents from the mirror web site if the patents exist in the mirror web site.

Other objects, advantages and novel features of the present invention will be drawn from the following detailed description thereof with the attached drawings, in which:

### BRIEF DESCRIPTION OF THE DRAWINGS

FIG. 1 is a schematic diagram of hardware configuration and an application environment of a patent downloading system according to a preferred embodiment of the present invention;

FIG. 2 is a schematic diagram of function modules of an application server of the patent downloading system of FIG. 1;

FIG. 3 is a schematic diagram of function modules of a web server of the patent downloading system of FIG. 1;

FIG. 4 is a flowchart of a preferred patent downloading method according to the present invention, utilizing the patent downloading system of FIG. 1; and

FIG. 5 is a flowchart of a process of periodically downloading patents from a patent web site according to the present invention.

### DETAILED DESCRIPTION OF THE INVENTION

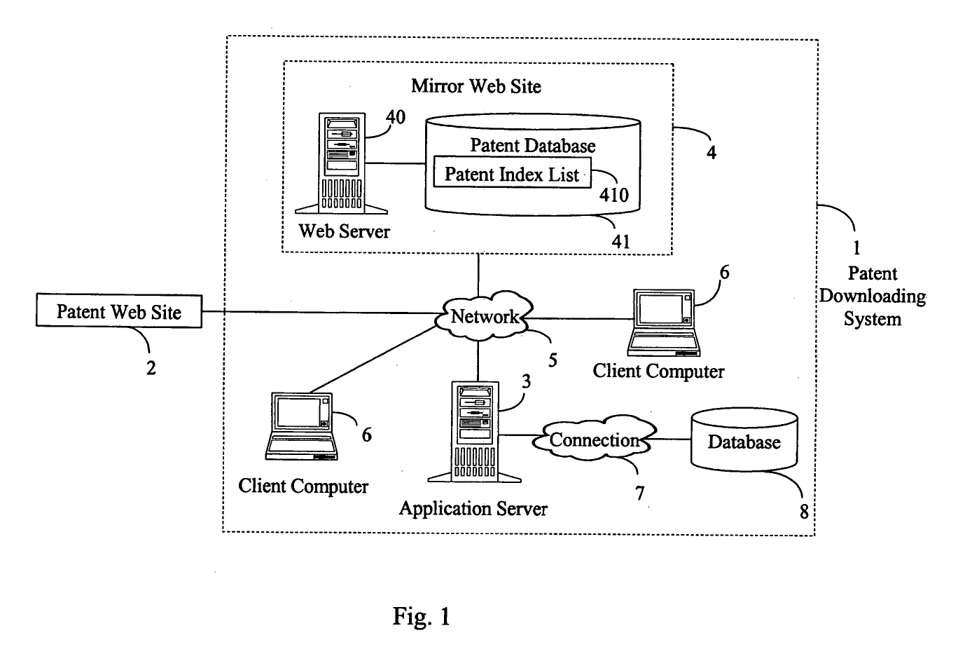

FIG. 1 is a schematic diagram of hardware configuration and an application environment of a patent downloading system 1 in accordance with the preferred embodiment of the present invention. The patent downloading system 1 comprises an application server 3, a mirror web site 4, a plurality of client computers 6 (only two shown), and a database 8. Each client computer 6 is connected with the application server 3 through a common network 5. The network 5 may be any suitable communication architecture required by the patent downloading system 1, such as a local area network or a wide area network. Each client computer 6 is programmed to provide an interactive user interface for users of the patent downloading system 1 to input patent inquiry terms, and to view downloaded issued patents and published patent applications. The patent downloading system 1 is also connected with a plurality of patent web sites 2 (only one shown) through the network 5. Each patent web site 2 stores issued patents and published patent applications. The patent web site 2 may for example be the United States Patent and Trademark Office (USPTO) web site, the European Patent Office (EPO) web site, the State Intellectual Property Office of P.R. China (SIPO) web site, the Taiwan Intellectual Property Office (TIPO) web site, etc. A patent web site 2 is accessed by a user to inquire of patent information in a particular area of technology. The user can then download the patent information from the patent web site 2, and store corresponding patent indexes. Unless otherwise indicated, the term “patent” as used herein is to be construed as including a published patent application, and the term “issued patent” as used herein is to be construed as including a published patent application.

The database 8 is connected with the application server 3 through a connection 7, and is used to store issued patents downloaded by the application server 3. The connection 7 is a kind of database connectivity such as an ODBC (Open Database Connectivity) or a JDBC (Java Database Connectivity). The mirror web site 4 is connected with the application server 3 through the network 5, and comprises a web server 40 and a patent database 41. The web server 40 comprises a plurality of function modules (described in detail below in relation to FIG. 3), and is provided to periodically download newly issued patents from the patent web sites 2 at predetermined download times. A download time is a fixed point in time at the end of a download period. A download period is a periodical interval of time between every two successive download times, and may for example be one day, one week or one month. The patent database 41 is connected with the web server 40 through a database connectivity (not labeled), and is programmed to store the newly issued patents downloaded by the web server 40 and also store corresponding patent indexes. The patent database 41 comprises at least one patent index list 410. Each patent index list 410 corresponds to one particular patent web site 2. Each patent index is stored in a patent index list 410, and is created according to a download time, a patent web site name and a patent number or patent application number. For example, a patent index “US200308016594641” represents a U.S. Pat. No. 6,594,641 downloaded from the USPTO web site during a first download period of August, 2003.

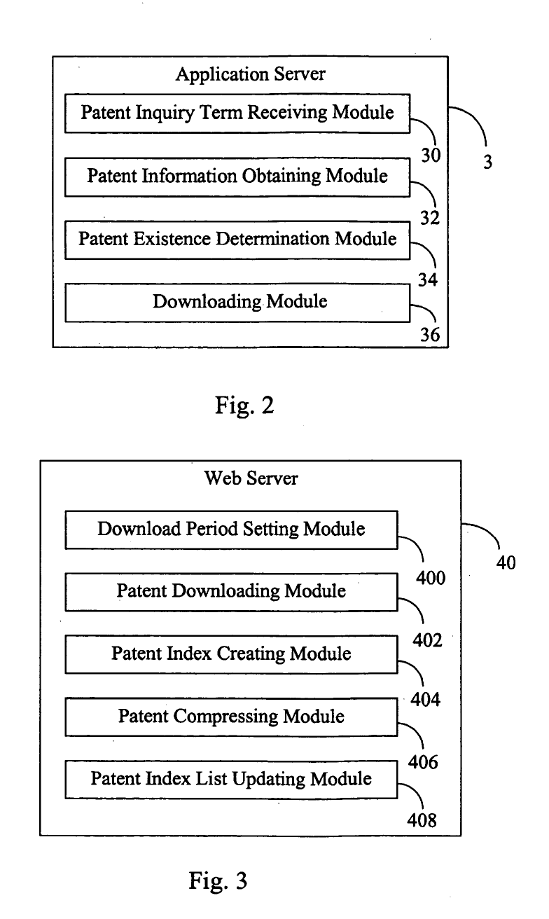

The application server 3 comprises a plurality of software function modules (described in detail below in relation to FIG. 2), and is provided to: receive patent inquiry terms; obtain information on patents to be downloaded according to the received patent inquiry terms; determine whether the patents to be downloaded exist in the database 8 or in the patent index list 410 stored in the patent database 41; and download the patents from the mirror web site 4 if the patents exist in the patent index list 410, or download the patents from a corresponding patent web site 2 if the patents do not exist in the database 8 nor in the patent database 41. The information on each patent typically comprises a patent number and a patent title. The information on each patent application typically comprises a patent application number and a patent application title.

FIG. 2 is a schematic diagram of function modules of the application server 3. The application server 3 comprises a patent inquiry term receiving module 30, a patent information obtaining module 32, a patent existence determination module 34, and a downloading module 36. The patent inquiry term receiving module 30 is provided to receive patent inquiry terms from the client computers 6 which are input by users. The patent information obtaining module 32 is provided to obtain information on patents to be downloaded according to the received patent inquiry terms. The patent existence determination module 34 is provided to determine whether the patents to be downloaded exist in the database 8 according to the information on patents to be downloaded, and to determine whether the patents to be downloaded exist in the patent index list 410 if the patents do not exist in the database 8. The downloading module 36 is provided to download patents from the mirror web site 4 if the patents exist in the patent index list 410, and to download the patents from a corresponding patent web site 2 if the patents do not exist in the database 8 nor in the patent index list 410.

FIG. 3 is a schematic diagram of software function modules of the web server 40. The web server 40 comprises a download period setting module 400, a patent downloading module 402, a patent index creating module 404, a patent compressing module 406, and a patent index list updating module 408. The download period setting module 400 is provided to set download periods. The patent downloading module 402 is provided to periodically download newly issued patents at a download time of each download period. The patent index creating module 404 is provided to create a patent index for each newly downloaded patent according to a patent web site name, a download time, and a patent number (or patent application number). The patent compressing module 406 is provided to compress the newly downloaded patents, and to store the compressed patents in the patent database 41. The patent index list updating module 408 is provided to update the patent index list 410 according to the created patent indexes.

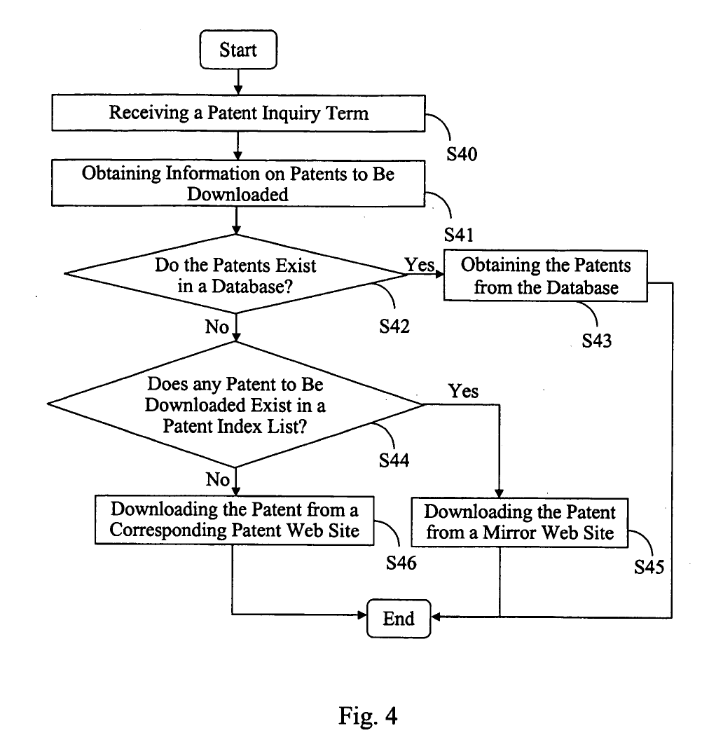

FIG. 4 is a flowchart of a preferred patent downloading method in accordance with the present invention. In step S40, the patent inquiry term receiving module 30 receives a patent inquiry term from a client computer 6 which is input by a user. In step S41, the patent information obtaining module 32 obtains information on patents to be downloaded according to the received patent inquiry term. In step S42, the patent existence determination module 34 determines whether the patents to be downloaded exist in the database 8 according to the information on the patents to be downloaded. If all the patents to be downloaded exist in the database 8, in step S43, the application server 3 obtains the patents from the database 8. If any patent to be downloaded does not exist in the database 8, in step S44, the patent existence determination module 34 determines whether the patent exists in the patent index list 410 stored in the patent database 41 according to the information on patents to be downloaded. If the patent exists in the patent index list 410 stored in the patent database 41, in step S45, the downloading module 36 downloads the patent from the mirror web site 4. If the patent does not exist in the patent index list 410, in step S46, the downloading module 36 downloads the patent from a corresponding patent web site 2.

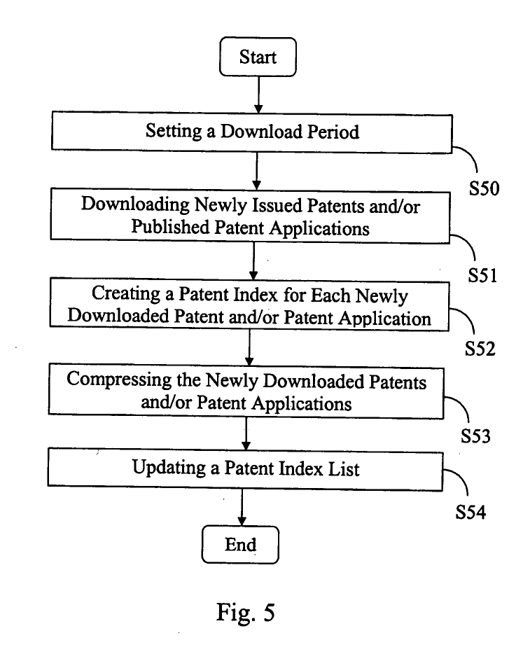

FIG. 5 is a flowchart of a process of periodically downloading patents from a patent web site 2 in accordance with the present invention. In step S50, the download period setting module 400 sets a download period. In step S51, the patent downloading module 402 periodically downloads newly issued patents at a download time of each download period from the patent web site 2. In step S52, the patent index creating module 404 creates a patent index for each newly downloaded patent according to the patent web site name, the download period, and the patent number (or patent application number). In step S53, the patent compressing module 406 compresses the downloaded patents, and stores the compressed patents in the patent database 41. In step S54, the patent index list updating module 408 updates the patent index list 410 according to the newly created patent indexes.

Although the present invention has been specifically described on the basis of a preferred embodiment and preferred method, the invention is not to be construed as being limited thereto. Various changes or modifications may be made to said embodiment and method without departing from the scope and spirit of the invention.

1. A system for downloading patents from one or more patent web sites through a network, the system comprising a mirror web site, an application server, one or more client computers, and a database linking to the application server through a connection, wherein:
the mirror web site comprises:
a patent database for storing newly issued patents downloaded from said patent web sites and for storing corresponding patent index lists; and
a web server comprising:
a download period setting module for setting download periods;
a patent downloading module for periodically downloading newly issued patents at a predetermined download time of each download period; and
a patent index creating module for creating a patent index for each newly downloaded patent; and
the application server comprises:
a patent inquiry term receiving module for receiving one or more patent inquiry terms from any of said client computers;
a patent information obtaining module for obtaining information on patents to be downloaded according to said received patent inquiry terms;
a patent existence determination module for determining whether the patents to be downloaded exist in the mirror web site;
a downloading module for downloading patents from the mirror web site if the patents exist in the mirror web site; and
a patent is to be construed as including a published patent application, and an issued patent is to be construed as including a published patent application.

2. The system according to claim 1, wherein the web server further comprises a patent compressing module for compressing the newly downloaded patents and storing the compressed patents in the patent database.

3. The system according to claim 1, wherein the web server further comprises a patent index list updating module for updating said patent index lists according to newly created patent indexes.

4. The system according to claim 1, wherein the patent existence determination module is also for determining whether the patents to be downloaded exist in the database.

5. The system according to claim 1, wherein the downloading module is also for directly downloading the patents from a corresponding patent web site if the patents do not exist in the database nor in the mirror web site.

6. A method for downloading patents from one or more patent web sites through a network, the method comprising:
providing a mirror web site for periodically downloading newly issued patents from said patent web sites and storing the downloaded patents;
receiving a patent inquiry term;
obtaining information on patents to be downloaded according to the received patent inquiry term;
determining whether the patents to be downloaded exist in the mirror web site; and
downloading the patents from the mirror web site if the patents exist in the mirror web site; wherein
a patent is to be construed as including a published patent application, and an issued patent is to be construed as including a published patent application.

7. The method according to claim 6, further comprising the step of setting a download period.

8. The method according to claim 6, further comprising the step of creating a patent index for each newly downloaded patent.

9. The method according to claim 6, further comprising the step of compressing the newly downloaded patents.

10. The method according to claim 8, further comprising the step of updating a patent index list according to newly created patent indexes.

11. The method according to claim 6, further comprising the step of determining whether the patents to be downloaded exist in a database.

12. The method according to claim 11, further comprising the step of directly downloading patents from a corresponding patent web site if the patents do not exist in the database nor in the mirror web site.

13. A method for downloading patents from one or more patent web sites through a network, the method comprising:
providing a mirror web site for automatically and periodically downloading newly issued patents from said patent web sites and storing the downloaded patents;
receiving a patent inquiry term;
obtaining information on patents to be downloaded according to the received patent inquiry term;
downloading the patents from the mirror web site if the patents exist in the mirror web site or from at least one of said web sites if the patents do not exist in the mirror web.

14. The method as claimed in claim 13, wherein said patent includes the images showing texts and drawings.
